(19) United States
(12) Patent Application Publication
(10) Pub. No.: US 2026/0270889 A1
(43) Pub. Date: Sep. 10, 2026

(54) Radio Nodes and Methods for Power Control of Transmit Symbols based on Their Symbol Type while Taking Into Account of Radio Node Power Headroom

(71) Applicant: Telefonaktiebolaget LM Ericsson (publ), Stockholm (SE)

(72) Inventors: Peter Alriksson, Hörby (SE); Stephen Grant, Pleasanton, CA (US); Abhishek Ambede, Huddinge (SE); Jung-Fu Cheng, Fremont, CA (US); Thomas Chapman, Solna (SE)

(21) Appl. No.: 19/471,407

(22) PCT Filed: Mar. 25, 2024
(86) PCT No.: PCT/SE2024/050263

§ 371 Date: Oct. 1, 2025

Related U.S. Application Data
(60) Provisional application No. 63/494,466, filed on Apr. 6, 2023.

(51) Int. Cl. H04W 52/36; H04W 52/08; H04W 52/10; H04W 52/24

(52) U.S. Cl. CPC H04W 52/365; H04W 52/08; H04W 52/10; H04W 52/241

(57) ABSTRACT

A method performed by a first radio node The method is for controlling a transmission power level for transmitting one or more symbols in a channel to a second radio node in a wireless communications network. The first radio node obtains (901), for the respective one or more symbols, one or more transmission power parameters. The one or more transmission power parameters are related to the respective symbol type of the respective one or more symbols to be transmitted. The first radio node determines (903), based on the one or more transmission power parameters, a respective transmission power level to be used for transmitting the respective one or more symbols. The respective transmission power level is determined by taking an available power headroom in the first radio node into account. The first radio node then transmits (904) the one or more symbols with the determined respective transmission power level in the channel to the second radio node.

### TECHNICAL FIELD

Embodiments herein relate to a first radio node, a second radio node and methods therein. In some aspects, they relate to controlling a transmission power level for transmitting one or more symbols in a channel from the first radio node to the second radio node.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

The NR standard in 3GPP is being designed to provide service for multiple use cases such as enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot may consist of any number of 1 to 14 Orthogonal Frequency-Division Multiplexing (OFDM) symbols. It should be noted that the concepts of slot and mini-slot are not specific to a specific service meaning that a mini-slot may be used for either eMBB, URLLC, or other services. FIG. 1 shows an exemplary radio resource in NR.

In 3GPP Release15 NR, a UE can be configured with up to four carrier bandwidth parts in the downlink with a single downlink carrier bandwidth part being active at a given 5 time. A UE can be configured with up to four carrier bandwidth parts in the uplink with a single uplink carrier bandwidth part being active at a given time.

An NR slot comprises several OFDM symbols, according to current agreements either 7 or 14 symbols (OFDM subcarrier spacing s 60 kHz) and 14 symbols (OFDM subcarrier spacing >60 kHz). FIG. 2 shows a subframe with 14 OFDM symbols. In FIG. 2 Tₛ and T_{symb} denote the slot and OFDM symbol duration, respectively.

FDD and TDD systems Transmission and reception from a node, e.g., a terminal in a cellular system, may be multiplexed in the frequency domain or in the time domain, or combinations thereof. Frequency Division Duplex (FDD) as illustrated to the left in FIG. 3 implies that downlink and uplink transmission take place in different, sufficiently separated, frequency bands. Time Division Duplex (TDD), as illustrated to the right in FIG. 3, implies that downlink and uplink transmission take place in different, non-overlapping time slots. Thus, TDD can operate in unpaired spectrum, whereas FDD requires paired spectrum.

Typically, the structure of the transmitted signal in a communication system is organized in the form of a frame structure. For example, NR uses ten equally-sized slots per radio frame as illustrated in FIG. 1 for the case of 15 kHz subcarrier spacing.

In case of FDD operation, left part of FIG. 3, there are two carrier frequencies, one for uplink transmission (f_{UL}) and one for downlink transmission (f_{DL}). At least with respect to the terminal in a cellular communication system, FDD may be either full duplex or half duplex. In the full duplex case, a terminal may transmit and receive simultaneously, while in half-duplex operation, the terminal cannot transmit and receive simultaneously. The base station is capable of simultaneous reception/transmission though, e.g., receiving from one terminal while simultaneously transmitting to another terminal. In LTE, a half-duplex terminal is monitoring and/or receiving in the downlink except when explicitly being instructed to transmit in a certain subframe.

In the case of TDD operation, right part of FIG. 3, there is only a single carrier frequency and uplink and downlink transmissions are always separated in time also on a cell basis. As the same carrier frequency is used for uplink and downlink transmission, both the base station and the mobile terminals need to switch from transmission to reception and vice versa. An essential aspect of any TDD system is to provide the possibility for a sufficiently large guard time where neither downlink nor uplink transmissions occur. This is required to avoid interference between uplink and downlink transmissions. For NR, this guard time is provided by special subframes, which are split 5 into three parts: symbols for DL, a guard period (GP), and symbols for uplink. The remaining subframes are either allocated to uplink or downlink transmission.

### Subband Full Duplex

As described in the last section, in a conventional TDD system, the entire carrier Bandwidth (BW) or all carriers in the same frequency band need to be utilizing the same DL transmission or UL reception directions. This is further illustrated in FIG. 4.

For the 3GPP Release 18 evolution of the NR system, 3GPP has decided to study the technical feasibility and potential benefits of Subband Full Duplex (SBFD) systems.

In such a system, a portion of a wide bandwidth carrier may be used for a different direction than that of the rest of the carrier. This is illustrated in the left-hand side of FIG. 5. That is, unlike a conventional TDD system as shown on the left-hand side of FIG. 4 where the entire bandwidth is used for DL transmission in the first three slots, the center portion of the SBFD carrier is used for UL reception while the rest of the carrier continues to be used for DL transmission as shown in the left-hand side of FIG. 5.

Similarly, instead of utilizing all carriers for the same DL or UL directions in a conventional TDD system as shown in the right-hand side of FIG. 4, some carriers in the SBFD system can be used for a different direction than that of the other carriers as shown in the right-hand side of FIG. 5.

The slots/symbols where simultaneous UL and DL is allowed are referred to as full duplex symbols (FD), and symbols where only either DL or UL is allowed are referred to as non-FD symbols. Subband full duplex (SBFD) as depicted above is a special case of full duplex where the UL and DL resources are separated in frequency.

### Power Control

In 3GPP TS 38.213 Section 7, UL power control is specified for Physical Uplink Shared Channel (PUSCH), Physical Uplink Control Channel (PUCCH), and Sounding Reference Signal (SRS). Here some background is provided for the example of PUSCH.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{g , f , c} ( i , l )\end{matrix}\end{matrix} \}$$

The UE computes the transmit power for PUSCH (in dBm) for UL BWP b of carrier f of serving cell c during PUSCH occasion i according to the following formula:

Since power control is performed separately for each carrier and updated for each PUSCH occasion i, this formula can be simplified as follows for the purposes of discussion:

$${P}_{PUSCH} ( {q}_{d} , l ) = min \{ \begin{matrix}{P}_{CMAX} \\ {P}_{0 \_ PUSCH} ( j ) + α ( j ) \cdot PL ( {q}_{d} ) + 10 {log}_{10} ( {2}^{μ} {M}_{RB}^{PUSCH} ) + {Δ}_{TF} + f ( l )\end{matrix} \}$$

where
   P_{CMAX} is the maximum UE Tx power per carrier, known to UE.
   P_{0_PUSCH}(j) is a target receive power level, signaled to UE.
   PL(q_{d}) is the path loss between gNB and UE, estimated by the UE.
   α(j) is a fractional path loss compensation term, signaled to the UE.

$${M}_{RB}^{PUSCH}$$

MRSCH is the number of RBs assigned to the UE for PUSCH transmission, signaled to the UE.
μ is the SCS configuration where, e.g., μ=0, 1, 3 correspond to 15 kHz, 30 kHz, and 120 kHz, respectively, signaled to the UE.
Δ_{TF} is a factor that depends on the MCS and coding rate used for the PUSCH transmission, signaled to the UE.
f(l) is a power control state determined by the current or current+previous PUSCH Transmit Power Control (TPC) commands, calculated by the UE.

In order to calculate the transmit power for PUSCH, the UE must determine the “open loop” power component P_{0_PUSCH}(j)+α(j)·PL(q_{d}). The parameter P_{0_PUSCH}(j) is the target receive power at the gNB which is provided to the UE by RRC configuration. By adding the quantity α(j)·PL(q_{d}), either partial or full compensation of the path loss is achieved depending on the value of α(j) configured to the UE. Full compensation occurs if α(j)=1, and partial compensation occurs if α(j)<1. The purpose of using fractional pathloss compensation is so that UEs transmit with lower power in a larger portion of the cell than if full compensation is used. Clearly this lowers the received signal power at the gNB; however, it also reduces the interference created between cells, and can result in higher SINR on average.

Up to 4 pairs of {P_{PUSCH}(j), α(j)}values can be provided to the UE by RRC configuration and the pairs are indexed by j∈{0,1,2,3}. Which pair to use depends on what type of PUSCH is scheduled, e.g., scheduled PUSCH such as dedicated grant, configured grant, Msg3, etc. Also, different pairs may be associated with different values of the SRS Resource Indicator (SRI) field of the scheduling Downlink Control Information (DCI) for the case of a scheduled PUSCH, so that which pair to use can be indicated dynamically.

To determine the open loop power component, the UE must estimate the path loss PL(q_{d}). The UE estimates the path loss by measuring the reference signal received power (RSRP) of a particular reference signal, either SSB or periodic CSI-RS. The UE may maintain up to 4 path loss references indexed by q_{d} ∈{0,1,2,3}. Different path loss references are associated with different transmit-receive beam pairs for beam-based power control, e.g., for use in frequency range 2 (FR2). As the UE moves and the best beam pair changes, the gNB may dynamically indicate to the UE which path loss reference to use for a given beam pair in order to determine the PUSCH power. The dynamic indication is via the SRI field in the scheduling DCI, where each codepoint in the SRI field is associated with a different value of q_{d} by RRC configuration.

After computing the open loop power component, the UE must compute the closed loop component f(l), which is referred to as the PUSCH power control state. The UE may be configured to maintain one or two states which are indexed by l∈{0,1}. The closed loop component f(l) is computed based on the TPC commands dynamically signaled by the network to the UE in the DCI that schedules PUSCH, e.g., DCI 0_1, or in a group common DCI addressing multiple users, e.g., DCI 2_2. The TPC command indicates to the UE to adjust its transmit power up or down by a certain step size in dB. The gNB decides on the step size to indicate to the UE based on measurement of a particular metric and comparison of the measured metric to a target value. For example, the metric may be received power, SINR, SNR, interference level, etc. A TPC command consists of 2 bits, thus allowing 4 possible step sizes.

Two modes for power control exist depending on the configuration of the parameter tpc-Accumulation:
Non-accumulative mode:
   The power control state f(l) is determined by the step size corresponding to the currently indicated TPC command only.
   The possible steps indicated by the TPC command are {−4, −1, 1, 4}dB. See Table 7.1.1-1 from 3GPP TS 38.213 Section 7.1.1 below.
Accumulative mode (default):
   The power control state f(l) is determined by the step size corresponding to the currently indicated TPC command plus a sum of the step sizes corresponding to previous TPC commands.
   The possible steps indicated by the TPC command are {−1, 0, 1, 3}dB.

Table 7.1.1-1 from from 3GPP TS 38.213: Mapping of TPC Command Field in a DCI format scheduling a PUSCH transmission, or in DCI format 2_2 with Cyclic Redundancy Check (CRC)scrambled by TPC-PUSCH-RNTI, or in DCI format 2_3, to absolute and accumulated δ_{PUSCH,b,f,c} values or δ_{SRS,b,f,c} values.

TABLE 7.1.1-1

| | Accumulated | Absolute |
|---|---|---|
| TPC | δ_{PUSCH,b,f,c} or | δ_{PUSCH,b,f,c} or |
| Command Field | δ_{SRS,b,f,c} [dB] | δ_{SRS,b,f,c} [dB] |
| 0 | −1 | −4 |
| 1 | 0 | −1 |
| 2 | 1 | 1 |
| 3 | 3 | 4 |

Note that in accumulative mode, the default mode, the TPC command may indicate a step of 0 dB meaning that the UE should not change its transmit power. This is because the scheduling DCI always contains a TPC command, and the gNB may not want the UE to change its transmission power. If the gNB always indicates 0 dB, then power control is operating as “open-loop.” Otherwise, it is operating as closed loop.

In case two Physical Uplink Shared Channel (PUSCH) power control states f(l) are maintained for I∈{0,1}, the power control mode, accumulative or non-accumulative, is the same for both. Maintenance of two power control states may be useful when the UE switches UL beams to maintain a constant receive power.

### SUMMARY

An object of embodiments herein is to improve the way of controlling a transmission power level for transmissions in a wireless communications network.

According to an aspect of embodiments herein, the object is achieved by a method performed by a first radio node for controlling a transmission power level for transmitting one or more symbols in a channel to a second radio node in a wireless communications network. The first radio node obtains, for the respective one or more symbols, one or more transmission power parameters. The one or more transmission power parameters are related to the respective symbol type of the respective one or more symbols to be transmitted. The first radio node determines, based on the one or more transmission power parameters, a respective transmission power level to be used for transmitting the respective one or more symbols. The respective transmission power level is determined by taking an available power headroom in the first radio node into account. The first radio node then transmits the one or more symbols with the determined respective transmission power level in the channel to the second radio node.

According to another aspect of embodiments herein, the object is achieved by a method performed by a second radio node. The method is for controlling a transmission power level for a transmission of one or more symbols in a channel from a first radio node to the second radio node in a wireless communications network. The second radio node determines one or more transmission power adjustments parameters for the transmission of the one or more symbols in the channel from the first radio node to the second radio node. The second radio node provides the one or more transmission power adjustments parameters to the first radio node. The second radio node receives the one or more symbols from the first radio node according to the provided one or more transmission power adjustments parameters.

According to another aspect of embodiments herein, the object is achieved by a first radio node configured to control a transmission power level for transmitting one or more symbols in a channel to a second radio node in a wireless communications network. The first radio node is further configured to:
obtain, for the respective one or more symbols, one or more transmission power parameters, wherein the one or more transmission power parameters are adapted to be related to the respective symbol type of the respective one or more symbols to be transmitted,
determine, based on the one or more transmission power parameters, a respective transmission power level adapted to be used for transmitting the respective one or more symbols, wherein the respective transmission power levels are determined taking an available power headroom in the first radio node into account, and
transmit the one or more symbols with the determined respective transmission power level in the channel to the second radio node.

According to yet another aspect of embodiments herein, the object is achieved by a second radio node configured to control a transmission power level for a transmission of one or more symbols in a channel from a first radio node to the second radio node in a wireless communications network. The second radio node is further configured to:
determine one or more transmission power adjustments parameters for the transmission of the one or more symbols in the channel from the first radio node to the second radio node,
provide the one or more transmission power adjustments parameters to the first radio node, and
receive the one or more symbols from the first radio node according to the provided one or more transmission power adjustments parameters.

Embodiments may e.g., provide the advantage of independently controlling the transmission power for FD and non-FD symbols. This may allow a good trade-off between maintaining a good SINR and not causing unnecessary interference and excess power consumption. Further, it may allow a simpler receiver implementation for scenarios where a larger power headroom is available, because one may allow a higher interference level in FD symbols.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic block diagram illustrating prior art.

FIG. 4 is a schematic block diagram illustrating prior art.

FIG. 5 is a schematic block diagram illustrating prior art.

FIG. 6 is a diagram illustrating prior art.

FIG. 7 is a diagram illustrating an embodiment herein.

FIG. 8 is a schematic block diagram illustrating embodiments of a communications network.

FIG. 9 is a flowchart depicting an embodiment of a method in a first radio node.

FIG. 10 is a flowchart depicting an embodiment of a method in a second radio node.

FIG. 11 is a schematic block diagram illustrating embodiments of a first radio node.

FIG. 12 is a schematic block diagram illustrating embodiments of a second radio node.

FIG. 13 schematically illustrates embodiments of a communication system.

FIG. 14 is a generalized block diagram of embodiments of a UE.

FIG. 15 is a generalized block diagram of embodiments of a network node.

FIG. 16 is a generalized block diagram of embodiments of a host.

FIG. 17 is a generalized block diagram of embodiments of a virtualization environment.

FIG. 18 is a generalized block diagram of embodiments of a communication diagram of a host.

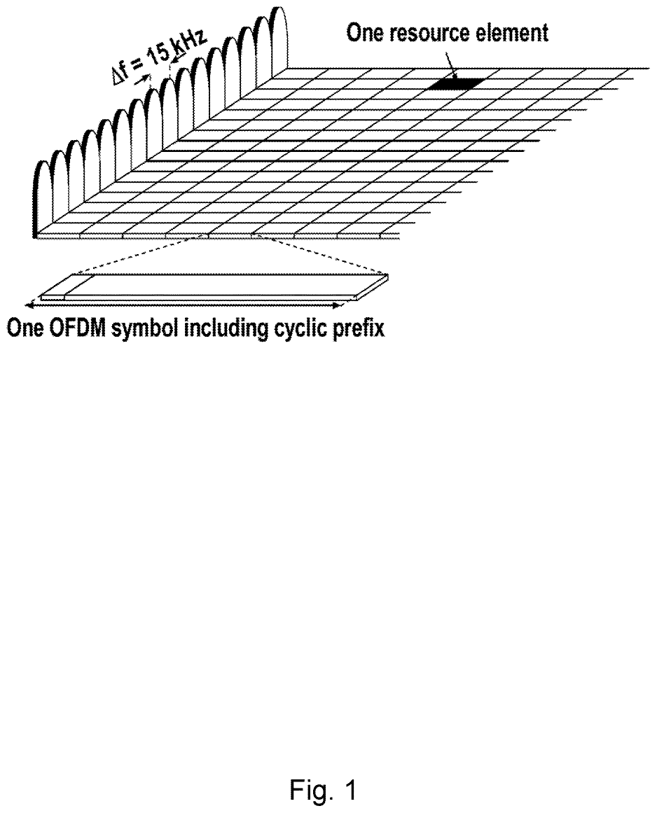

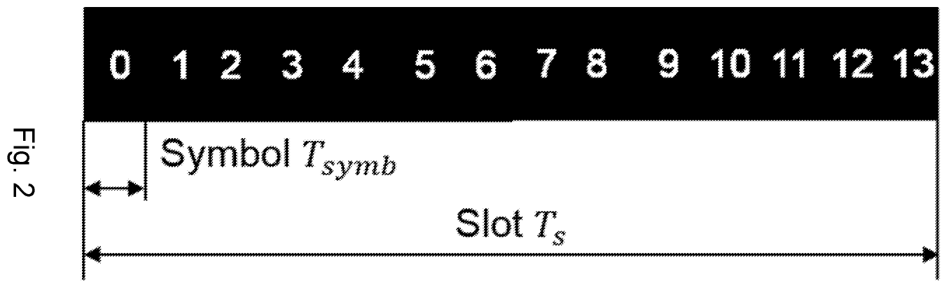

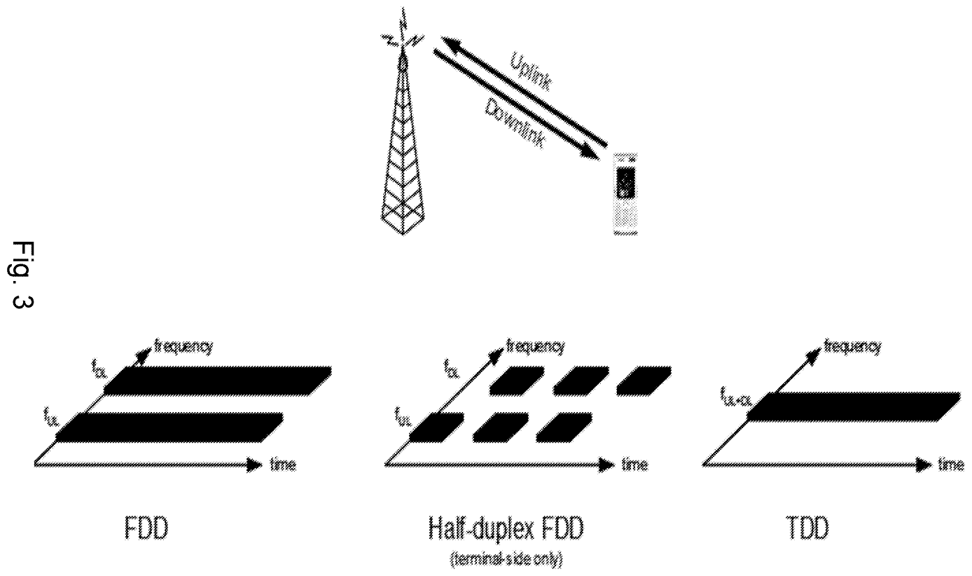

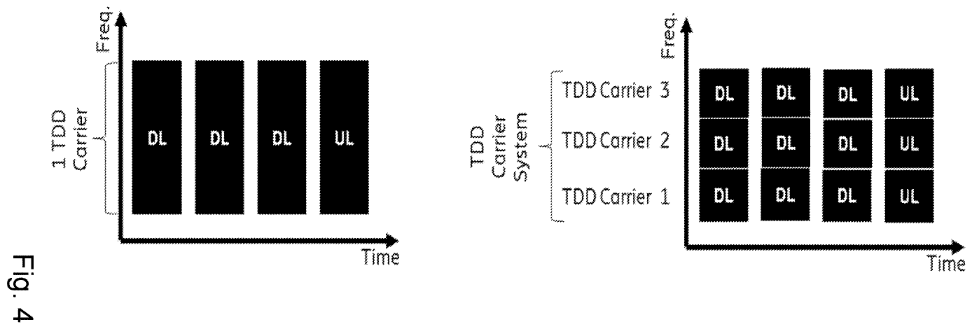

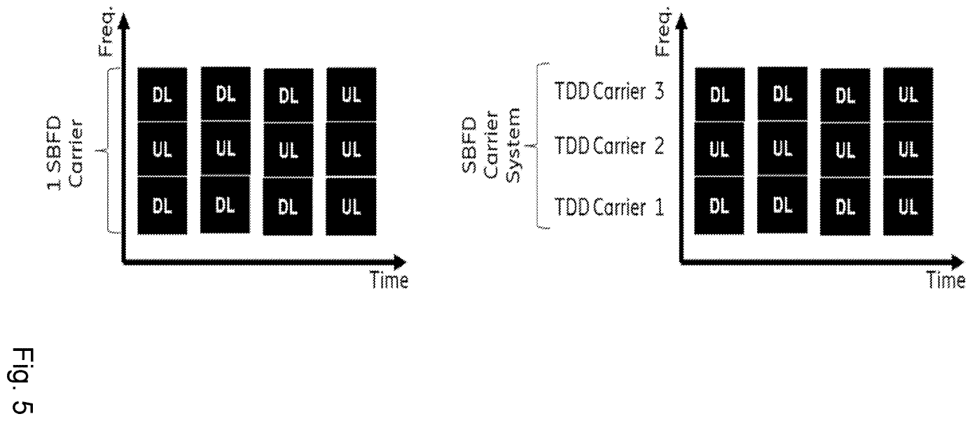

### DETAILED DESCRIPTION

As a part of developing embodiments herein the inventors identified a problem which first will be discussed.

In Full Duplex (FD), or SBFD, systems the interference level during UL reception may differ significantly between FD symbols and non-FD symbols. There are multiple sources of interference. For non-FD symbols interference comes from other UE's UL transmissions. For FD symbols, in addition to the interference from other UE's UL transmissions, there may be interference from gNB transmissions in DL. This interference may be from the same cell, self-interference, from other cells of the same network in the same site location, inter-sector interference, or from other cells in other locations, inter-site interference. In addition, other network's cells may also generate interference.

In traditional TDD or FDD systems the interference conditions on all symbols are typically similar, thus using the same UL power in all symbols is sufficient in most cases. However, in (SB)FD systems as discussed above, interference conditions may vary considerably between symbols. Thus, there is a need for a new power control method that can handle highly varying interference levels in a better way.

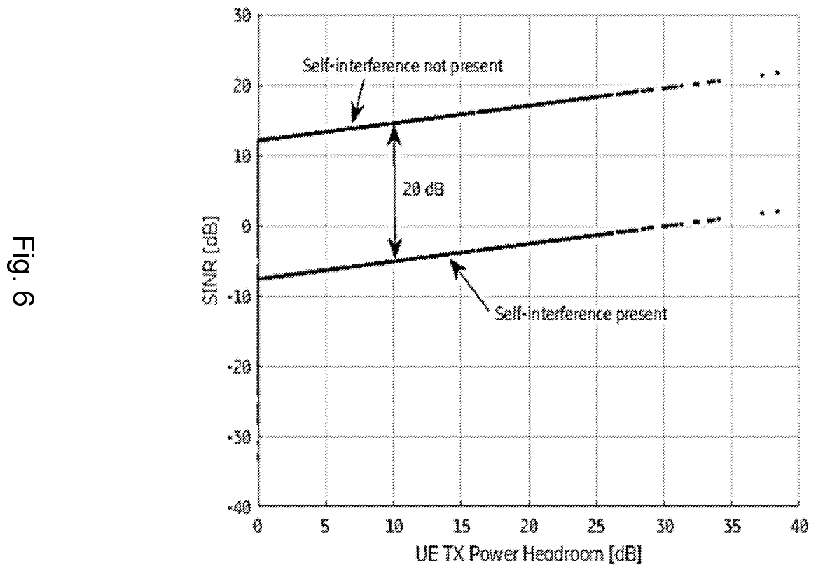

FIG. 6 illustrates the problem above. The figure shows the UL SINR including only noise and interference from the gNB's own DL transmission, self-interference, on the Y-axis. On the X-axis the UE power headroom is shown. Power headroom is the amount of power the UE has left compared to its maximum transmission power. The upper line corresponds to transmissions when there is no self-interference. The lower line corresponds to transmissions when there is self-interference present. The line on the Y-axis correspond to transmission that are already at full power, thus the power headroom is 0 dB. The slope of the two lines is due to that for this particular example fractional pathloss compensation is used, and thus the achieved SINR will depend on the pathloss and thus the power headroom. One may observe that when there is self-interference present, the SINR degrades by 20 dB.

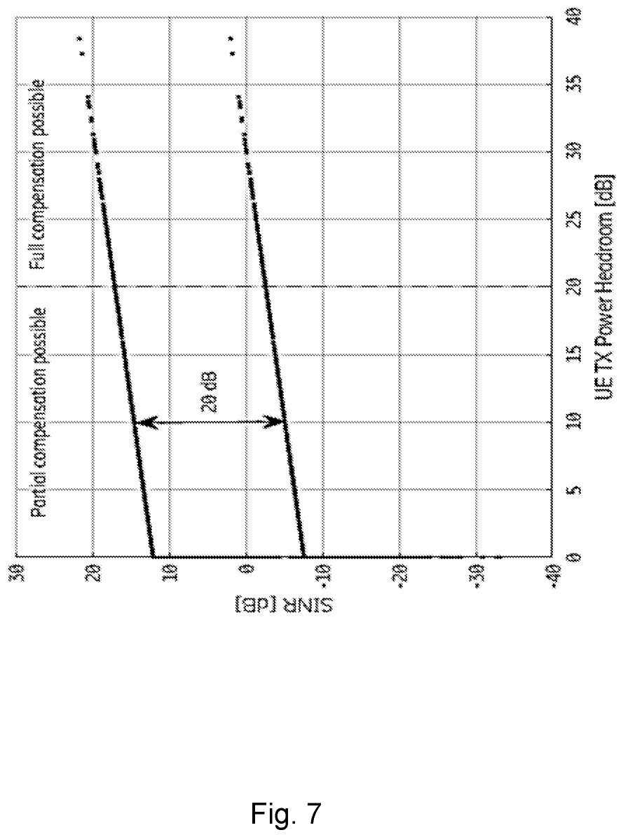

FIG. 7 illustrates an example according to embodiments herein. If the received signal is increased by 20 dB by increasing the TX power by 20 dB, the loss in SINR may be compensated for. This requires UEs to have at least 20 dB power headroom. Thus, for UEs with 20 dB or more power headroom, the loss in SINR may be fully compensated and for UEs with less than 20 dB power headroom the SINR loss may only be partly compensated for. Embodiments herein discloses different ways in which this may be achieved.

Examples of embodiments herein provides methods for controlling transmission power in at least two types of symbols where the transmission power in the first and second type of symbols may be different. According to examples of embodiments herein, different static open loop power control parameters may be configured per symbol type. Further, different static closed loop power adjustments may be configured per symbol type. Additional dynamic adjustments to the power control may be received by the UE for controlling the transmission power. The UE may reject and/or negotiate the power control adjustments. According to some examples of embodiments herein, an SBFD capable UE may determine whether it expects at least the serving cell to transmit in downlink during a slot and adjusts its transmit power accordingly. According to some examples of embodiments, the transmission is a multi-PUSCH/PUCCH transmission.

As mentioned above, embodiments may e.g., provide the advantage of independently controlling the transmission power for FD and non-FD symbols. This may allow a good trade-off between maintaining a good SINR and not causing unnecessary interference and excess power consumption. Further, it may allow a simpler receiver implementation for scenarios where a larger power headroom is available, because one may allow a higher interference level in FD symbols.

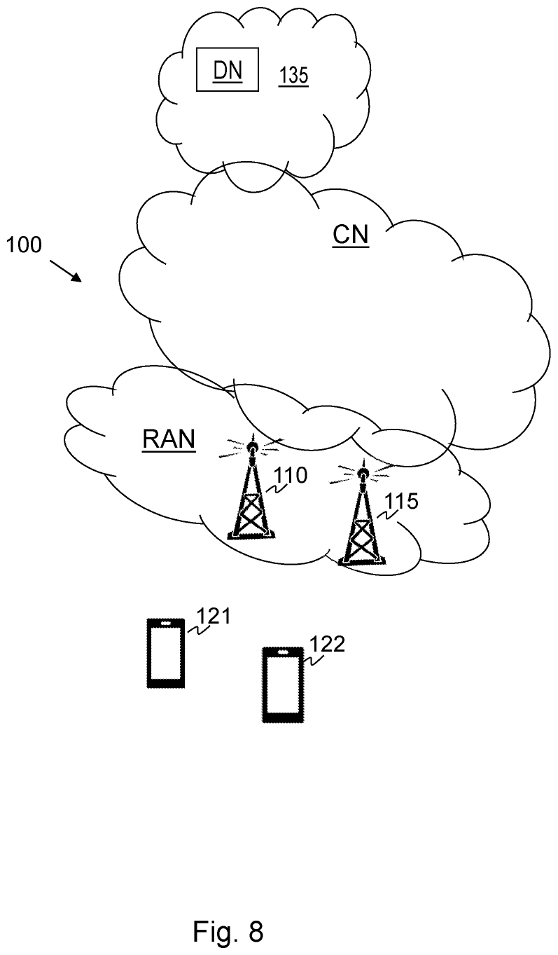

FIG. 8 is a schematic overview depicting a wireless communications network 100, wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a first radio node 110 and a second radio node 115, operate in the wireless communications network 100. Each of the radio nodes 110, 115 e.g. provides a number of cells and may use these cells for communicating with other network nodes. Each of the radio nodes 110, 115 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the radio node 110, 115 depending e.g. on the radio access technology and terminology used.

UEs, such as a first radio node 121 and a second radio node 122, which may also be referred to as UE 121 and UE 122, operate in the wireless communications network 100. The radio nodes 121, 122 may e.g. be an NR device, a mobile station, a wireless terminal, an IoT device, an IoS device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, a Vehicle-to-Network (V2N) device, a Wi-Fi device, an LTE device, a non-access point (non-AP) STA, a STA, that communicates via a base station such as e.g. the radio nodes 110, 115, and one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the first radio node 110, 121, and in another aspect by the second radio node 115, 122. As an alternative, a Distributed Node (DN) and functionality, e.g. comprised in a cloud 135 as shown in FIG. 8, may be used for performing or partly performing the methods of embodiments herein.

The cloud 135 may comprise a cloud network infrastructure. A cloud network infrastructure may e.g. be a collection of hardware and software elements such as computing power, networking, storage, and virtualization resources needed to enable cloud computing in a wireless communications network such as e.g. the wireless communications network 100.

A number of embodiments will now be described, some of which may be seen as alternatives, while some may be used in combination.

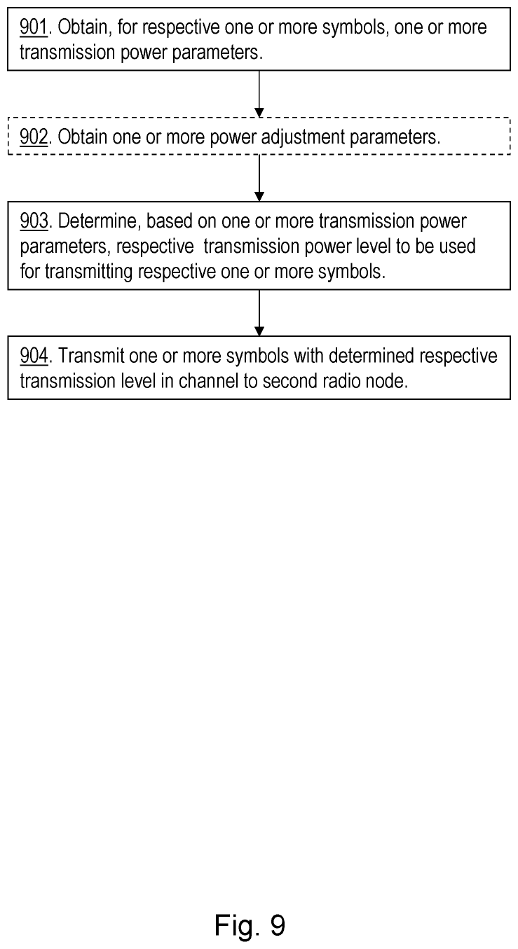

A method according to embodiments will now be described from the view of the UE 121 together with FIG. 9 and FIG. 8 as described above. FIG. 9 depicts example embodiments of a method performed by the first radio node 110, 121, e.g., for controlling a transmission power level for transmitting one or more symbols in a channel to the second radio node 115, 122 in a wireless communications network 100. The first radio node 110, 121 may e.g., a base station 110, such as a gNB 110 or an eNB 110, or the first radio node 110, 121 may e.g., be a UE 121. The second radio node 115, 122 may e.g., a base station 115, such as a gNB 115 or an eNB 115, or the second radio node 115, 122 may e.g., be a UE 122. The method comprises the following actions, which actions may be taken in any suitable order. Optional actions are referred to as dashed boxes in FIG. 9

### Action 901

The first radio node 110, 121 obtains, for the respective one or more symbols, one or more transmission power parameters. This is e.g., to at least partially compensate for interference and/or noise in the channel. The one or more transmission power parameters are related to the respective symbol type of the respective one or more symbols to be transmitted. In other words, for each of the one or more symbols, the first radio node 110, 121 obtains respective one or more transmission power parameters. As explained below, the respective one or more transmission power parameters may be used to determine a respective transmission power level for each of the one or more symbols. The respective one or more transmission power parameters is related to the symbol type of the symbol the respective one or more transmission power parameters is obtained for. Thus, the one or more transmission power parameters may differ, such as e.g., have different values and/or being different type of parameters, for the different one or more symbols depending on the symbol types of the one or more symbols.

The symbol type may e.g., be any one out of: A symbol where simultaneous reception and transmission is not allowed, or a symbol where simultaneous reception and transmission is allowed. As explained further below in some of the first to nineth embodiments, the symbol may be of several other types than the two mentioned above.

The one or more transmission parameters may e.g., comprise any one or more out of: one or more open loop transmission power parameters, and one or more closed loop transmission parameters. The open and closed loop transmission power parameters are explained further below in the Some first to nineth embodiments.

In some embodiments, obtaining the one or more transmission power parameters may comprise measuring a downlink power of downlink symbol, and determining a transmission power parameter based on the measured downlink power, which is explained further below in the Some first to nineth embodiments.

### Action 902

In some embodiments, the first radio node 110, 121 obtains one or more transmission power adjustments parameters from the second radio node 115, 122. This may comprise the first radio node 110, 121 receive the one or more transmission power adjustments parameters explicitly or implicitly, e.g., in a DCI. In some examples, the one or more transmission power parameters may indicate an offset value. In some examples, it may comprise the first radio node 110, 121 rejecting and/or negotiating the one or more transmission power adjustments parameters with the second radio node 115, 122. The obtaining of the one or more transmission power adjustments parameters are explained further below in the Some first to nineth embodiments.

### Action 903

The first radio node 110, 121 determines, based on the one or more transmission power parameters, a respective transmission power level to be used for transmitting the respective one or more symbols. The respective transmission power level is determined taking an available power headroom in the first radio node 110, 121 into account. The determined transmission power level, may e.g., at least partially, compensates for interference and/or noise in the channel. The determined transmission power level may e.g., at least partially, compensates for interference and/or noise in the channel. In other words, the first radio node 110, 121 determines a respective transmission power level for each of the one or more symbols to be transmitted. Thus, since each respective transmission power level is based on a respective one or more transmission power parameters, the respective transmission level may differ depending on the symbol type. By taking the available power headroom into account, the respective transmission power levels will not be determined to be higher than the maximum transmission power available for the first radio node 110, 121. In other words, when determining the respective transmission power levels, the first radio node 110, 121, is limited by its available power headroom. As explained further below in the some first to nineth embodiments, the first radio node 110, 121 may use the one or more transmission power parameters to determine the respective transmission power levels, e.g., by using any of the examples there.

In some embodiments, the respective transmission power level may further be determined based on the one or more transmission power adjustments parameters, which is explained further below in the Some first to nineth embodiments.

### Action 904

The first radio node 110, 121 transmits the one or more symbols with the determined respective transmission power level in the channel to the second radio node 115, 122. In other words, for each symbol, of the one or more symbols, its respective determined transmission power level is applied when transmitting the one or more symbols. Thus, each of the one or more symbols may be transmitted with different transmission power levels depending on e.g., symbol type and/or the available power headroom.

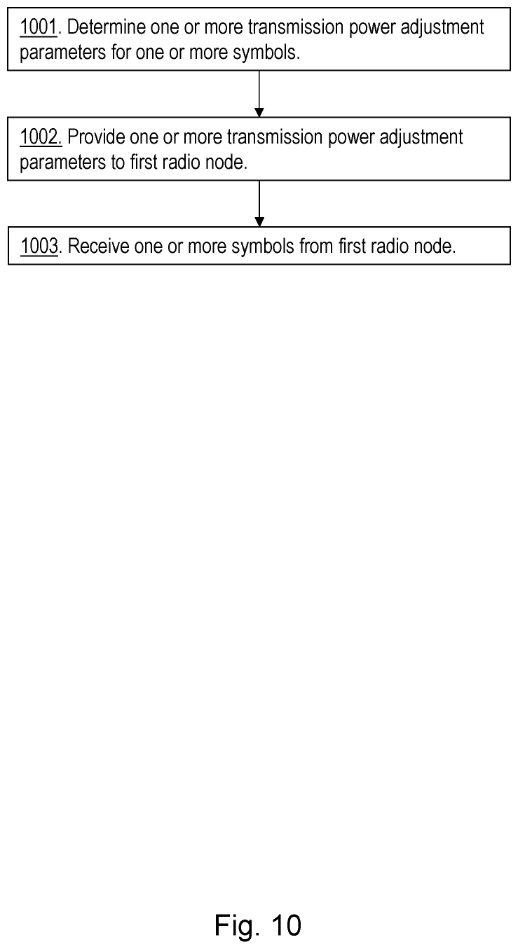

A method according to embodiments will now be described from the view of the UE 121 together with FIG. 10 and FIG. 8 as described above. FIG. 10 depicts example embodiments of a method performed by the second radio node 115, 122, e.g., for controlling a transmission power level for a transmission of one or more symbols in a channel from a first radio node 110, 121 to the second radio node 115, 122 in the wireless communications network 100. The first radio node 110, 121 may e.g., a base station 110, such as a gNB 110 or an eNB 110, or the first radio node 110, 121 may e.g., be a UE 121. The second radio node 115, 122 may e.g., a base station 115, such as a gNB 115 or an eNB 115, or the second radio node 115, 122 may e.g., be a UE 122. The method comprises the following actions, which actions may be taken in any suitable order. Optional actions are referred to as dashed boxes in FIG. 10

### Action 1001

The second radio node 115, 122 determines one or more transmission power adjustments parameters for the transmission of the one or more symbols in the channel from the first radio node 110, 121 to the second radio node 115, 122. The one or more transmission power adjustments parameters enables the first radio node 110, 121 to, e.g., at least partially compensate for interference and/or noise in the channel. This is explained further below in the Some first to nineth embodiments.

The one or more transmission power adjustment parameters may be determined based on any one or more out of: An observed uplink noise and/or interference in the channel, an observed uplink SINR, a type of downlink transmission from the second radio node 115, 122, a spatial rank of a downlink transmission from the second radio node 115, 122, and a spatial rank of an uplink transmission from the first radio node 110, 121.

As explained further below in the Some first to nineth embodiments, the symbol may be of several other types than the two mentioned above. The one or more power adjustments parameters may conditionally be determined based on one or more criteria.

### Action 1002

The second radio node 115, 122 provides the one or more transmission power adjustments parameters to the first radio node 110, 121.

In some examples, the second radio node 115, 122 further provides the respective one or more transmission power parameters, implicitly and/or explicitly, to the first radio node 110, 121. This is explained further below in the Some first to nineth embodiments.

### Action 1003

The second radio node 115, 122 receives the one or more symbols from the first radio node 110, 121 according to the provided one or more transmission power adjustments parameters. This may mean the one or more symbols are transmitted with respective transmission power levels determined based on the one or more transmission power adjustment parameters.

Embodiments herein such as the embodiments mentioned above will now be further described and exemplified. The text below is applicable to and may be combined with any suitable embodiment described above.

In the following description UE 121 and gNB 115 communicating in UL will be used as an example. Thus, the first radio node 110, 121 is here referred to as UE 121 and the second radio node 115, 122 is here referred to as gNB 115. This should not be seen as limiting. Embodiments herein may for example be applied to Sidelink communications where one UE controls the power of another UE, in such an example, the first radio node 110, 121 would be referred to as UE 121 and the second radio node 115, 122 would be referred to as UE 122. Further, embodiments herein may be used for power control of a wireless link between two gNBs, for example for the purpose of backhauling. In such an example the first radio node 110, 121 would be referred to as gNB 110 and the second radio node would be referred to as gNB 115. Further embodiments herein may be used for power control in DL, where the first radio node 110, 121 would be referred to as gNB 110 and the second radio node 115, 122 would be referred to as UE 122.

In the description herein, the transmission unit is an OFDM symbol and is referred to as a symbol. This should not be seen as limiting. The transmission unit may also e.g., be a slot, a set of slots, a sub-frame, a transmission burst, or any other transmission unit used in a radio access technology. In the description below, FD will be used. FD here comprises different variants such a frequency overlapping full duplex and sub-band full duplex. In the description below, two different symbol types are used. This should not be seen as limiting. The same embodiments may be applied to more than two symbol types.

### Some First Embodiments

According to examples of embodiments herein, the UE 121 may use different transmission power levels for transmitting different type of symbols. A symbol type may e.g., be:
A symbol where simultaneous reception and transmission is not allowed, e.g., a regular TDD symbol such as a non-FD symbol.
A symbol where a higher interference level than another symbol may be expected.
A symbol where simultaneous transmission and reception is allowed, for example an FD symbol.
An FD symbol where it is known that there is a simultaneous reception and transmission occurring.
An FD symbol where it is known that there is interference from the same node that tries to receive
An FD symbol where it is known that there is interference from another node than the one that tries to receive

Except in case of the first bullet above, it may be expected that a relatively higher transmission power is used by the UE in case of all other bullets.

### Some Second Embodiments

In this example of an embodiment, the UE 121 may use different open loop power control parameters, such as e.g., the one or more transmission power parameters, for different types of symbols. The parameters may, e.g., differ in the received power target and pathloss compensation value. In one example, the received power target is configured to be higher for symbols where a higher interference level may be expected compared to symbols where no elevated interference level is expected, for example the received power target may be configured to be higher for FD symbols than non-FD symbols.

In one example, the UE 121 may receive different sets of RRC parameters for the two symbol types. In another example, an offset to the parameters for the first symbol type is signaled for the second symbol type. For example, an offset for the received power target or pathloss compensation may be signaled.

As an example, the affected parameters are P_{0_PUSCH}(j) and α(j) in the equation shown below:

$${P}_{PUSCH} ( {q}_{d} , l ) = min \{ \begin{matrix}{P}_{CMAX} \\ {P}_{0 \_ PUSCH} ( j ) + α ( j ) \cdot PL ( {q}_{d} ) + 10 {log}_{10} ( {2}^{μ} {M}_{RB}^{PUSCH} ) + {Δ}_{TF} + f ( l )\end{matrix} \}$$

### Some Third Embodiments

In this example of an embodiment, the UE 121 may receive, such as obtain, independent closed loop adjustments, such as e.g., the one or more transmission power parameters, of the transmission power for the two types of symbols. This may be combined with different open loop parameters as described above.

As an example, the affected variable is f(l) in the equation shown below. In this example, the first symbol type may use f(1) and the second symbol type f(2).

$${P}_{PUSCH} ( {q}_{d} , l ) = min \{ \begin{matrix}{P}_{CMAX} \\ {P}_{0 \_ PUSCH} ( j ) + α ( j ) \cdot PL ( {q}_{d} ) + 10 {log}_{10} ( {2}^{μ} {M}_{RB}^{PUSCH} ) + {Δ}_{TF} + f ( l )\end{matrix} \}$$

### Some Fourth Embodiments

Some second embodiments and some third embodiments above mostly target the case when the second symbol type is a symbol with elevated interference levels in general. That is, when the transmitter does not have explicit knowledge of exactly when the interference will occur. These embodiments make sense to handle e.g., interference from other sites or other network's cells, where the receiving gNB 115, and thus the transmitting UE121, would not know if another gNB is transmitting in DL in this particular symbol, but rather the power control is based on an estimated long-term average indicating elevated interference levels compared to the non-FD symbols.

According to some examples of embodiments, for the cases when the gNB 115 has explicit knowledge of the interference conditions for a particular symbol, e.g., when the interference is self-interference, the gNB 115, may inform the UE 121 using e.g., DCI. To limit the amount of information transmitted in DCI, a set of parameters may be preconfigured.

One option may be to use RRC configuration to configure a set of transmission power offsets and then point to these offsets using DCI. This may be related to the one or more power adjustment parameters described above. These offsets would then be applied on top of the transmission power computed based on open and closed loop power control, as explained above. For example, if one bit is used, the UE 121 may be configured with one OdB offset and one offset that depends on the residual interference from a DL transmission. In case the DL transmission power is varying, additional offsets corresponding to those offsets may be configured, at the expense of more bits in the DCI. Practically, a gNB, such as the gNB 115 may have knowledge of DL transmissions within the same cell, self-interference, and potentially transmissions from other cells at the same site, inter-sector interference. That said, embodiments herein are not restricted to only interference from these sources. In case of very good backhaul, it may be considered information from other sites as well.

One way this additional power offset, such as e.g., the one or more transmission power adjustment parameters, may be introduced in the equation is shown below:

$${P}_{PUSCH} ( {q}_{d} , l ) = min \{ \begin{matrix}{P}_{CMAX} \\ \begin{matrix}{P}_{0 \_ PUSCH} ( j ) + α ( j ) \cdot PL ( {q}_{d} ) + 10 {log}_{10} ( {2}^{μ} {M}_{RB}^{PUSCH} ) + \\ {Δ}_{TF} + f ( l ) + g ( m )\end{matrix}\end{matrix} \}$$

where g(m) is an RRC configured list of offsets and m is indicated in DCI. This example may make most sense when combined with either pure open-loop power control or closed-loop power control using an accumulative mode. This allows the gNB 115 to use closed-loop power control to compensate for unknown interference and g(m) to compensate for known interference.

Another example may be to configure a set of open-loop received power control targets. In a similar way, as for the transmission power offset, the DCI may point to different open loop received power control targets. Alternatively, or additionally, a set of path loss compensation values can be configured in a similar way.

In an example of this embodiment, the UE 121 is configured with both accumulative and non-accumulative closed-loop adjustments corresponding to the two different symbol types, respectively. In one example, the UE 121 may apply accumulative closed loop adjustment to a first symbol type that is either configured, e.g., by RRC, or indicated, e.g., by SFI, as UL-only. The UE 121 may apply non-accumulative closed loop adjustment to a second symbol type when indicated. The indication may be received in a UE specific DCI that schedules and/or triggers the UL transmission, or in a group common DCI providing transmit power control commands (TPCs) for a group of UEs. The gNB 115 may choose to transmit non-accumulative TPC command to the UEs in advance of a symbol of the second symbol type, e.g., when the gNB 115 knows it will transmit DL simultaneously with receiving UL. Since the application time is known to the gNB 115, it may assure that the UE 121 applies the TPC command during the symbol of the second symbol type. The non-accumulative TPC command may thus provide a mechanism for the UE to increase its transmission power only during symbols in which simultaneous DL and UL transmissions occur. In other words, the non-accumulative TPC may be applied on top of the accumulative one.

As an example, the affected variables are f(l) and f′(l) in the equation shown below. In this example, the first symbol type would use f(1) and the second symbol type f(1)+f(1).

$${P}_{PUSCH} ( {q}_{d} , l ) = min \{ \begin{matrix}{P}_{CMAX} \\ \begin{matrix}{P}_{0 \_ PUSCH} ( j ) + α ( j ) \cdot PL ( {q}_{d} ) + 10 {log}_{10} ( {2}^{μ} {M}_{RB}^{PUSCH} ) + \\ {Δ}_{TF} + f ( l ) + {f}^{′} ( l )\end{matrix}\end{matrix} \}$$

In one example, the UE 121 may receive a user-specific DCI and based on information in the DCI determine the interference conditions for a particular symbol.

Based on the interference conditions, the UE 121 may select a set of power control parameters to use for the symbol.

In another example, the UE 121 may receive a group common DCI that is used to inform a group of UEs on the interference conditions for a particular symbol. Based on the interference conditions, a UE 121 may select a set of power control parameters to use for the symbol. In one example, the group common DCI may convey a slot format indicator (SFI), wherein the SFI indicates for each symbol in the slot whether the symbol is to be used for only DL transmission(s) or only UL transmission(s) or for simultaneous DL and UL transmissions. In the latter case, the UE 121 may determine that the interference is elevated and may apply power control parameters to compensate for the elevated interference.

### Some Fifth Embodiments

In this example of embodiments, signalling is introduced to enable the UE 121 to reject and/or negotiate the power control that is instructed by its serving gNB 115.

For example, if the UE121 shares its battery power among different communication technologies and/or systems in hardware, it may be unfavourable for the UE 121 to boost its power if there is a risk to create undesired in-device coexistence issues. In such examples, the UE 121 may want to reject the power boost instruction or to use a lower transmission power instead.

In another example, if the gNB 115 has requested an unfavourable power boost that may result in large draining of the UE's battery, the UE 121 may want to reject the power boost instruction or want to use a lower transmission power instead.

Thus, according to some examples of embodiments, the UE 121 may reject the power control received from the gNB 115, e.g., by ignoring it or by sending a message to the gNB 115. Alternatively, the UE 121 may negotiate with the gNB 115 in order to agree on another power control parameter, e.g., by sending and receiving messages with the gNB 115. The UE 121 may e.g., propose another power control parameter(s) that the gNB 115 may accept or send a counter proposal back to the UE 121.

### Some Sixth Embodiments

In 3GPP Release 18, the UE does not perform SBFD and thus may either transmit or receive, but not both. For 3GPP Release 19, it has been proposed to study the possibility of SBFD also at the UE side. This may be possible for e.g., CPE types of UE, and may bring the advantage that the UE may be able to increase its coverage or latency gain by utilizing all slots for UL.

A UE, such as the UE 121, that is capable of SBFD may make measurements of DL power whilst transmitting uplink. Based on the measurements on DL power, the UE 121 may estimate at least whether the transmitter in its serving cell, such as the gNB 115, is active or not. It may also have the capability to determine whether neighbor cells are active or not. If the UE 121 determines that it's serving cell or neighbor cells are active, according to some embodiments herein, the UE 121 may boost its transmit power to compensate for anticipated receiver interference at the gNB 115. The amount by which the UE 121 boosts it's transmit power may be determined in the specification or may be configured by the network, such as e.g., the gNB 115.

If the UE 121 would make measurements on the DL, it may for example measure in a first symbol and then apply transmit power in subsequent symbols according to the result.

An alternative example for the UE 121 to determine whether the serving cell will transmit may be monitoring the DCI. If the UE 121 itself is scheduled in downlink, then it would know that the gNB 115 transmitter will be active during its UL transmission. Alternatively, if the UE 121 detects DCI activity it could assume that another UE has been scheduled and so the gNB 115 transmitter will be activated. Alternatively, a group common DCI as in some fourth embodiments may be used.

### Some Seventh Embodiments

For transmissions that span multiple types of symbols, for example multi-slot PUSCH and PUCCH, the UE 121 may apply different transmission power as described in the embodiments above to different symbol types, even if they are part of the same multi-slot transmission. In one example, the UE 121 does not apply different transmission power if it is expected that gNB 115 will use joint channel estimation for the multi-slot transmission.

### Some Eighths Embodiments

According to some examples of embodiments herein, the power control adjustment parameters, such as the one or more transmission power adjustment parameters, may be calculated by the gNB 115 based on one or more of at least the following:
Observed network noise rise in the uplink of the channel.
   Increasing the transmit power of a single UE may improve the UL SINR of said UE, such as the UE 121. However, when the transmit power adjustments are applied similarly to UEs across a multitude of gNBs in the network, the network noise rise will increase correspondingly. Such network noise rise increase will decrease the expected SINR improvements for the UEs and, in the worst case, result in no SINR improvement.
   In one example of an embodiment, the gNB 115 determines the, e.g., dynamic, power control adjustment parameters based on the ratio between DL interference and the network noise rise. When the ratio between DL interference and the network noise rise is low, e.g., dynamic, power control adjustments should be restricted to smaller values. When the ratio between DL interference and the network noise rise is high, larger, e.g., dynamic, power control adjustments may be used.
      As an example, the ratio between DL interference and the network noise rise is 20 dB. Applying a +5 dB power adjustment to the UE 121 may improve the UE UL SINR by 5 dB. Applying a +20 dB power adjustment to the UE 121 may improve the UE UL SINR by 17 dB.
      As an example, the ratio between DL interference and the network noise rise is 10 dB. Applying a +5 dB power adjustment to the UE 121 may improve the UE UL SINR by 4 dB. However, applying a +20 dB power adjustment to the UE may improve the UE UL SINR by only 10 dB.
Observed UL SINR wherein the interference is the DL interference plus interference from one or more other sources.
   In an example of an embodiment, the gNB 115 may determine the, e.g., dynamic, power control adjustment parameters by comparing the observed SINR to a target SINR. When the SINR is above/below a target SINR, the gNB 115 may indicate a power down/up command to the UE 121.
The types of downlink transmissions.
   The gNB 115 may transmit UE-specific channels, such as UE-specific PDSCH and PDCCH, with greater beamforming directivity or system-wise channels, such as synchronization channels, PBCH and system-information related PDCCH and PDSCH, with wider beams to cover the cells.
      For narrower beams, the gNB 115 may apply beam nulling to suppress the interference to its own UL receivers more effectively. The gNB 115 may determine smaller dynamic power control adjustments to the UEs, such as the UE 121.
      For wider beams, such beam nulling is less effective. The gNB 115 may determine larger dynamic power control adjustments to the UEs, such as the UE 121.
The spatial ranks of the downlink transmissions.
   Beam nulling to suppress interference to the gNB's own UL receivers is less effective if the downlink transmissions consist of multi-layer MIMO signals. The gNB 115 may determine larger dynamic power control adjustments to the UEs, such as the UE 121, when the downlink transmissions consist of higher spatial ranks.
The spatial ranks of the uplink transmissions.
   When receiving the UL transmissions from a UE, such as the UE 121, the gNB 115 may use multiple receiver antenna ports to perform receiver side beamforming to amplify the desired UL signals and suppress other interferences. Such receiver side suppression of interference is more effective when the UL transmissions consist of lower spatial ranks than of higher spatial ranks. The gNB 115 may determine larger, e.g., dynamic, power control adjustments to the UEs, such as the UE 121 when the UL transmissions consist of higher spatial ranks.

Further, the usage of higher transmission power for one or more UL OFDM symbols by the UE 121, e.g., during FD operation at the gNB 115, is conditional. Factors considered for making a corresponding assessment and decision may be based on one or more out of:
Whether increased transmission power by the UE 121 would lead to unfavorable UE-to-UE CLI in the same cell or across neighboring cells.
Whether increased transmission power by the UE 121 would cause unfavorable interference to the UL reception in a neighboring cell served by a gNB located at the same site or another site,
Whether increased transmission power by the UE 121 would lead to breaking of regulatory transmission power limits,
Whether increased transmission power by the UE 121 would lead to unfavorable draining of battery power of the UE 121, or whether the UE 121 battery power is already below a threshold,

In a related example of an embodiment, the corresponding assessment and decision of whether to use or not use a certain higher transmission power by the UE 121 is either independently made by the gNB 115, or made with a message exchange, e.g., involving measurement reports, between the two.

### Some Nineth Embodiments

In some examples, e.g., when it is assessed that power control alone may not suffice for compensating the SINR loss during UL reception, e.g., during FD operation at the gNB 115, of a signal transmitted by the UE 121, the serving gNB 115 may use additional techniques to aid in increasing the probability of successful UL reception. Some examples of such additional techniques may be:
Scheduling the UL with a more robust modulation and coding scheme (MCS),
Scheduling the UL with narrower transmission bandwidth such that UE 121 may boost the PSD of the transmission,
Scheduling the UL from the UE 121 only when it is assessed that the probability of suffering, e.g., high, SINR loss is low.

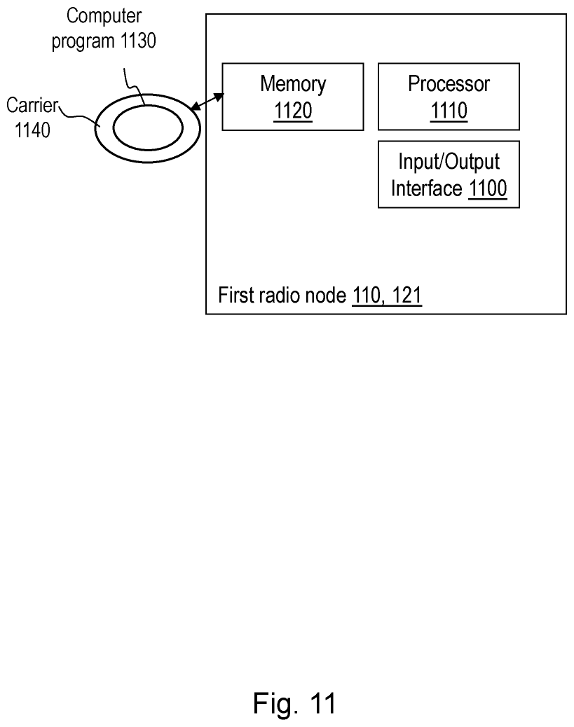

FIG. 11 shows an example of arrangement in the first radio node 110, 121.

The first radio node 110, 121 may comprise an input and output interface 1100 configured to communicate with each other. The input and output interface 1100 may comprise a receiver, e.g. wired and/or wireless, (not shown) and a transmitter, e.g. wired and/or wireless, (not shown).

The first radio node 110, 121 is, e.g., configured to control a transmission power level for transmitting one or more symbols in the channel to the second radio node 115, 122 in the wireless communications network 100.

The first radio node 110, 121 obtains, for the respective one or more symbols, one or more transmission power parameters to, e.g., at least partially compensate for interference and/or noise in the channel, wherein the one or more transmission power parameters are adapted to be related to the respective symbol type of the respective one or more symbols to be transmitted.

The first radio node 110, 121 determines, based on the one or more transmission power parameters, a respective transmission power level adapted to be used for transmitting the respective one or more symbols, wherein the respective transmission power levels are determined taking an available power headroom in the first radio node 110, 121 into account, wherein the determined transmission power level, e.g., at least partially compensates for interference and/or noise in the channel.

The first radio node 110, 121 transmit the one or more symbols with the determined respective transmission power level in the channel to the second radio node 115, 122.

In some embodiments, the symbol type is adapted to be, e.g., any one out of:
A symbol where simultaneous reception and transmission is not allowed, or
a symbol where simultaneous reception and transmission is allowed.

In some embodiments, the one or more transmission parameters are adapted to comprise, e.g., any one or more out of:
One or more open loop transmission power parameters, and
one or more closed loop transmission parameters.

In some embodiments, the first radio node 110, 121 is further configured to obtain one or more transmission power adjustments parameters from the second radio node 115, 122, and wherein the respective transmission power level is further adapted to be determined based on the one or more transmission power adjustments parameters.

In some embodiments, to obtain the one or more transmission power parameters is adapted to comprise to measure a downlink power of downlink symbol, and determine a transmission power parameter based on the measured downlink power.

The embodiments herein may be implemented through a respective processor or one or more processors, such as at least one processor 1110 of a processing circuitry in the first radio node 110, 121 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the first radio node 110, 121. One such carrier may be in the form of a CD ROM disc. It is however feasible with other data carriers such as a memory stick. The computer program code may furthermore be provided as pure program code on a server and downloaded to the first radio node 110, 121.

The first radio node 110, 121 may further comprise respective a memory 1120 comprising one or more memory units. The memory 1120 comprises instructions executable by the processor 1110 in the first radio node 110, 121.

The memory 1120 is arranged to be used to store instructions, data, configurations, identifiers, indications, parameters, resources, allocations, tables, and applications to perform the methods herein when being executed in the first radio node 110, 121.

In some embodiments, a computer program 1130 comprises instructions, which when executed by the at least one processor 1110, cause the at least one processor 1110 of the first radio node 110, 121 to perform the actions above.

In some embodiments, a respective carrier 1140 comprises the respective computer program 1130, wherein the carrier 1130 is one of an electronic signal, an optical signal, an electromagnetic signal, a magnetic signal, an electric signal, a radio signal, a microwave signal, or a computer-readable storage medium.

Those skilled in the art will also appreciate that the functional modules in the first radio node 110, 121, described below may refer to a combination of analog and digital circuits, and/or one or more processors configured with software and/or firmware, e.g. stored in the first radio node 110, 121, that when executed by the respective one or more processors such as the at least one processor 1110 described above cause the respective at least one processor 1110 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

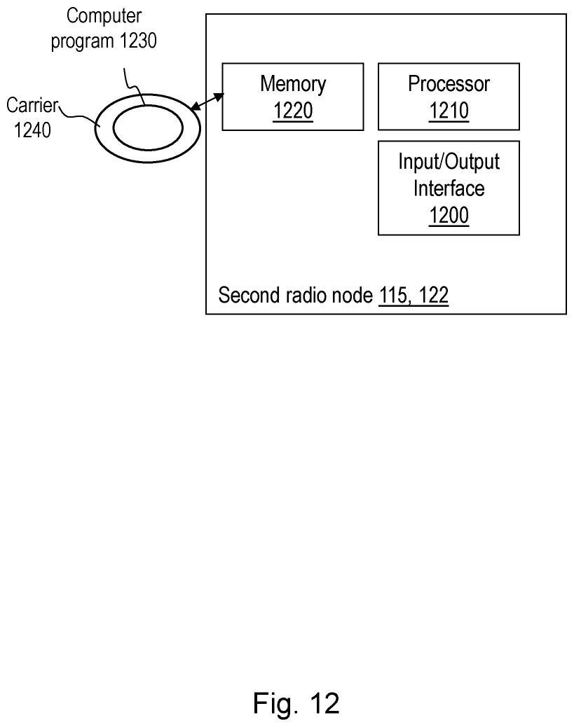

FIG. 12 shows an example of arrangement in the second radio node 115, 122.

The first radio node 110, 121 may comprise an input and output interface 1100 configured to communicate with each other. The input and output interface 1100 may comprise a receiver, e.g. wired and/or wireless, (not shown) and a transmitter, e.g. wired and/or wireless, (not shown).

The second radio node 115, 122 is, e.g., configured to control a transmission power level for a transmission of one or more symbols in the channel from the first radio node 110, 121 to the second radio node 115, 122 in the wireless communications network 100.

The second radio node 115, 122 determines one or more transmission power adjustments parameters for the transmission of the one or more symbols in the channel from the first radio node 110, 121 to the second radio node 115, 122, wherein the one or more transmission power adjustments parameters are adapted to enable the first radio node 110, 121 to, e.g., at least partially compensate for interference and/or noise in the channel.

The second radio node 115, 122 provides the one or more transmission power adjustments parameters to the first radio node 110, 121.

The second radio node 115, 122 receive the one or more symbols from the first radio node 110, 121 according to the provided one or more transmission power adjustments parameters.

In some embodiments, the one or more transmission power adjustment parameters are adapted to be determined based on any one or more out of:
An observed uplink noise and/or interference in the channel,
an observed uplink SINR,
a type of downlink transmission from the second radio node 115, 122,
a spatial rank of a downlink transmission from the second radio node 115, 122, and
a spatial rank of an uplink transmission from the first radio node 110, 121.

In some embodiments, the one or more power adjustments parameters are adapted to be conditionally determined based on one or more criteria.

The embodiments herein may be implemented through a respective processor or one or more processors, such as at least one processor 1210 of a processing circuitry in the second radio node 115, 122 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the second radio node 115, 122. One such carrier may be in the form of a CD ROM disc. It is however feasible with other data carriers such as a memory stick. The computer program code may furthermore be provided as pure program code on a server and downloaded to the second radio node 115, 122.

The second radio node 115, 122 may further comprise respective a memory 1220 comprising one or more memory units. The memory 1220 comprises instructions executable by the processor 1210 in the second radio node 115, 122.

The memory 1220 is arranged to be used to store instructions, data, configurations, identifiers, indications, parameters, resources, allocations, tables, and applications to perform the methods herein when being executed in the second radio node 115, 122.

In some embodiments, a computer program 1230 comprises instructions, which when executed by the at least one processor 1210, cause the at least one processor 1210 of the second radio node 115, 122 to perform the actions above.

In some embodiments, a respective carrier 1240 comprises the respective computer program 1230, wherein the carrier 1230 is one of an electronic signal, an optical signal, an electromagnetic signal, a magnetic signal, an electric signal, a radio signal, a microwave signal, or a computer-readable storage medium.

Those skilled in the art will also appreciate that the functional modules in the second radio node 115, 122, described below may refer to a combination of analog and digital circuits, and/or one or more processors configured with software and/or firmware, e.g. stored in the second radio node 115, 122, that when executed by the respective one or more processors such as the at least one processor 1210 described above cause the respective at least one processor 1210 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### EMBODIMENTS

Below, some example Embodiments 1-20 are shortly described. See e.g., FIGS. 9-12.
Embodiment 1. A method performed by a first radio node 110, 121, e.g., for controlling a transmission power level for transmitting one or more symbols in a channel to a second radio node 115, 122 in a wireless communications network 100, the method comprising:
obtaining 901, for the respective one or more symbols, one or more transmission power parameters to, e.g., at least partially, compensate for interference and/or noise in the channel, wherein the one or more transmission power parameters are related to the respective symbol type of the respective one or more symbols to be transmitted,
determining 903, based on the one or more transmission power parameters, a respective transmission power level to be used for transmitting the respective one or more symbols, wherein the respective transmission power level is determined taking an available power headroom in the first radio node 110, 121 into account, wherein the determined transmission power level, e.g., at least partially, compensates for interference and/or noise in the channel, and
transmitting 904 the one or more symbols with the determined respective transmission power level in the channel to the second radio node 115, 122.
Embodiment 2. The method according to embodiment 1, wherein the symbol type is, e.g., any one out of:
   a symbol where simultaneous reception and transmission is not allowed, or
   a symbol where simultaneous reception and transmission is allowed.
Embodiment 3. The method according to any of embodiments 1-2, wherein the one or more transmission parameters comprises, e.g., any one or more out of:
one or more open loop transmission power parameters, and
one or more closed loop transmission parameters.
Embodiment 4. The method according to any of embodiments 1-3, wherein the method further comprises:
obtaining 902 one or more transmission power adjustments parameters from the second radio node 115, 122, and wherein the respective transmission power level is further determined 903 based on the one or more transmission power adjustments parameters.
Embodiment 5. The method according to any of embodiments 1-4, wherein obtaining 901 the one or more transmission power parameters comprises measuring a downlink power of downlink symbol, and determining a transmission power parameter based on the measured downlink power.
Embodiment 6. A computer program 1130 comprising instructions, which when executed by a processor 1110, causes the processor 1110 to perform actions according to any of the embodiments 1-5.
Embodiment 7. A carrier 1140 comprising the computer program 1130 of embodiment 6, wherein the carrier 1140 is one of an electronic signal, an optical signal, an electromagnetic signal, a magnetic signal, an electric signal, a radio signal, a microwave signal, or a computer-readable storage medium.
Embodiment 8. A method performed by a second radio node 115, 122, e.g., for controlling a transmission power level for a transmission of one or more symbols in a channel from a first radio node 110, 121 to the second radio node 115, 122 in a wireless communications network 100, the method comprising:
determining 1001 one or more transmission power adjustments parameters for the transmission of the one or more symbols in the channel from the first radio node 110, 121 to the second radio node 115, 122, wherein the one or more transmission power adjustments parameters enables the first radio node 110, 121 to, e.g., at least partially, compensate for interference and/or noise in the channel,
providing 1002 the one or more transmission power adjustments parameters to the first radio node 110, 121, and
receiving 1003 the one or more symbols from the first radio node 110, 121 according to the provided one or more transmission power adjustments parameters.
Embodiment 9. The method according to embodiment 8, wherein the one or more transmission power adjustment parameters are determined 1001 based on any one or more out of:
   an observed uplink noise and/or interference in the channel,
   an observed uplink Signal to Interference and Noise Ratio, SINR,
   a type of downlink transmission from the second radio node 115, 122,
   a spatial rank of a downlink transmission from the second radio node 115, 122, and
   a spatial rank of an uplink transmission from the first radio node 110, 121.
Embodiment 10. The method according to any of embodiments 8-9, wherein the one or more power adjustments parameters are conditionally determined 1001 based on one or more criteria.
Embodiment 11. A computer program 1230 comprising instructions, which when executed by a processor 1210, causes the processor 1230 to perform actions according to any of the embodiments 8-10.
Embodiment 12. A carrier 1240 comprising the computer program 1230 of embodiment 11, wherein the carrier 1240 is one of an electronic signal, an optical signal, an electromagnetic signal, a magnetic signal, an electric signal, a radio signal, a microwave signal, or a computer-readable storage medium.
Embodiment 13. A first radio node 110, 121, e.g., configured to control a transmission power level for transmitting one or more symbols in a channel to a second radio node 115, 122 in a wireless communications network 100, the first radio node 110, 121 further being configured to:
obtain, for the respective one or more symbols, one or more transmission power parameters to, e.g., at least partially, compensate for interference and/or noise in the channel, wherein the one or more transmission power parameters are adapted to be related to the respective symbol type of the respective one or more symbols to be transmitted,
determine, based on the one or more transmission power parameters, a respective transmission power level adapted to be used for transmitting the respective one or more symbols, wherein the respective transmission power levels are determined taking an available power headroom in the first radio node 110, 121 into account, wherein the determined transmission power level, e.g., at least partially, compensates for interference and/or noise in the channel, and
transmit the one or more symbols with the determined respective transmission power level in the channel to the second radio node 115, 122.
Embodiment 14. The first radio node 110, 121 according to embodiment 13, wherein the symbol type is adapted to be, e.g., any one out of:
   a symbol where simultaneous reception and transmission is not allowed, or
   a symbol where simultaneous reception and transmission is allowed.
15. The first radio node 110, 121 according to any of embodiments 13-14, wherein the one or more transmission parameters are adapted to comprise, e.g., any one or more out of:
   one or more open loop transmission power parameters, and
   one or more closed loop transmission parameters.
Embodiment 16. The first radio node 110, 121 according to any of embodiments 13-15, wherein the first radio node 110, 121 is further configured to:
obtain one or more transmission power adjustments parameters from the second radio node 115, 122, and wherein the respective transmission power level is further adapted to be determined based on the one or more transmission power adjustments parameters.
Embodiment 17. The first radio node 110, 121 according to any of embodiments 13-16, wherein to obtain the one or more transmission power parameters is adapted to comprise to measure a downlink power of downlink symbol, and determine a transmission power parameter based on the measured downlink power.
Embodiment 18. A second radio node 115, 122, e.g., configured to control a transmission power level for a transmission of one or more symbols in a channel from a first radio node 110, 121 to the second radio node 115, 122 in a wireless communications network 100, the second radio node 115, 122 further being configured to:
determine one or more transmission power adjustments parameters for the transmission of the one or more symbols in the channel from the first radio node 110, 121 to the second radio node 115, 122, wherein the one or more transmission power adjustments parameters are adapted to enable the first radio node 110, 121 to, e.g., at least partially, compensate for interference and/or noise in the channel,
provide the one or more transmission power adjustments parameters to the first radio node 110, 121, and
receive the one or more symbols from the first radio node 110, 121 according to the provided one or more transmission power adjustments parameters.
Embodiment 19. The second radio node 115, 122 according to embodiment 18, wherein the one or more transmission power adjustment parameters are adapted to be determined based on any one or more out of:
an observed uplink noise and/or interference in the channel,
an observed uplink Signal to Interference and Noise Ratio, SINR,
a type of downlink transmission from the second radio node 115, 122,
a spatial rank of a downlink transmission from the second radio node 115, 122, and
a spatial rank of an uplink transmission from the first radio node 110, 121.
Embodiment 20. The second radio node 115, 122 according to any of embodiments 18-19, wherein the one or more power adjustments parameters are adapted to be conditionally determined based on one or more criteria.

### ADDITIONAL EXPLANATION

Some of the embodiments contemplated herein will now be described more fully with reference to the accompanying drawings. Embodiments are provided by way of example to convey the scope of the subject matter to those skilled in the art.

FIG. 13 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection.

In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

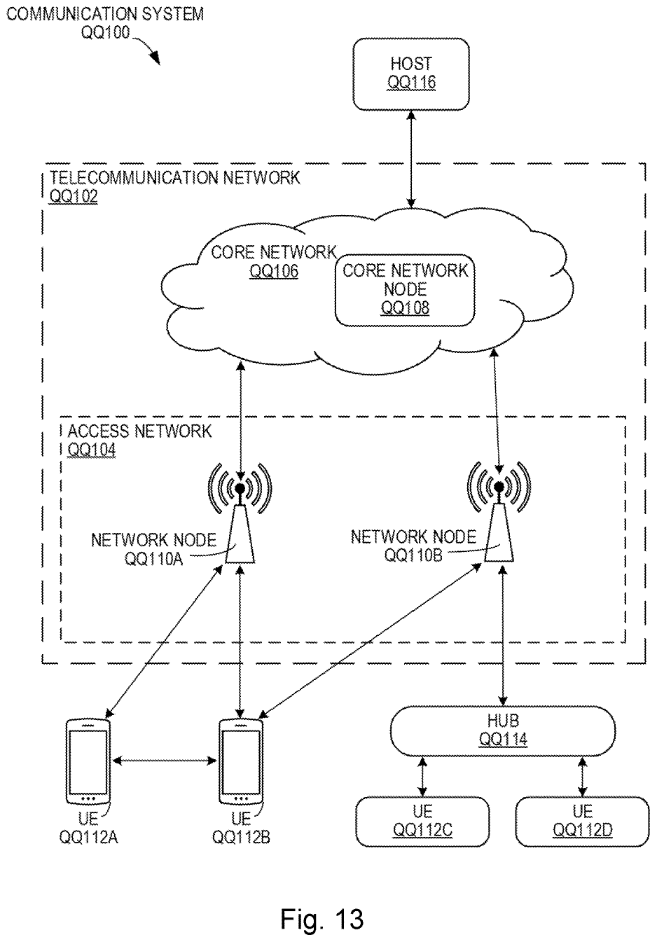

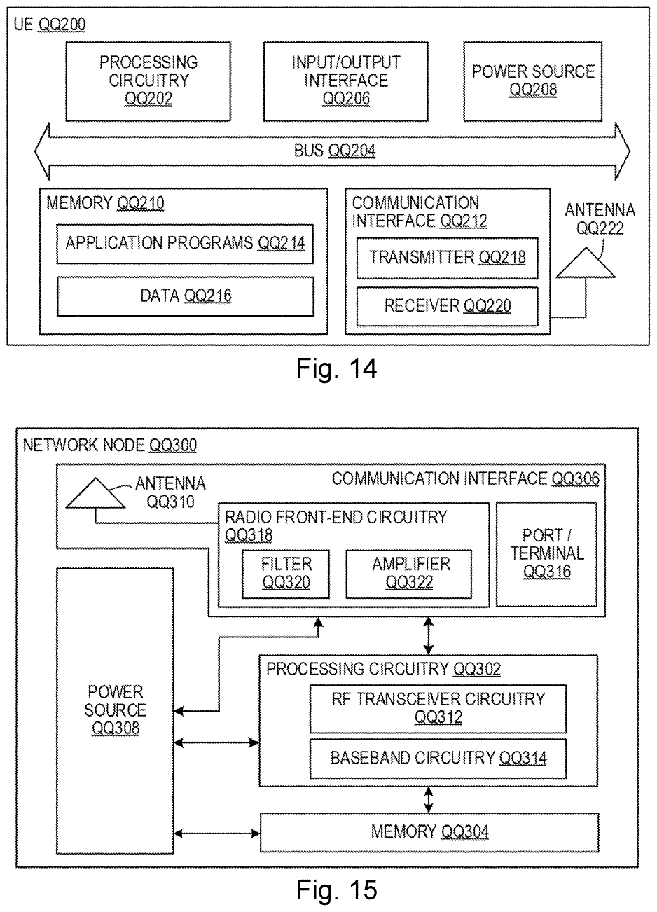

FIG. 14 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 15 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

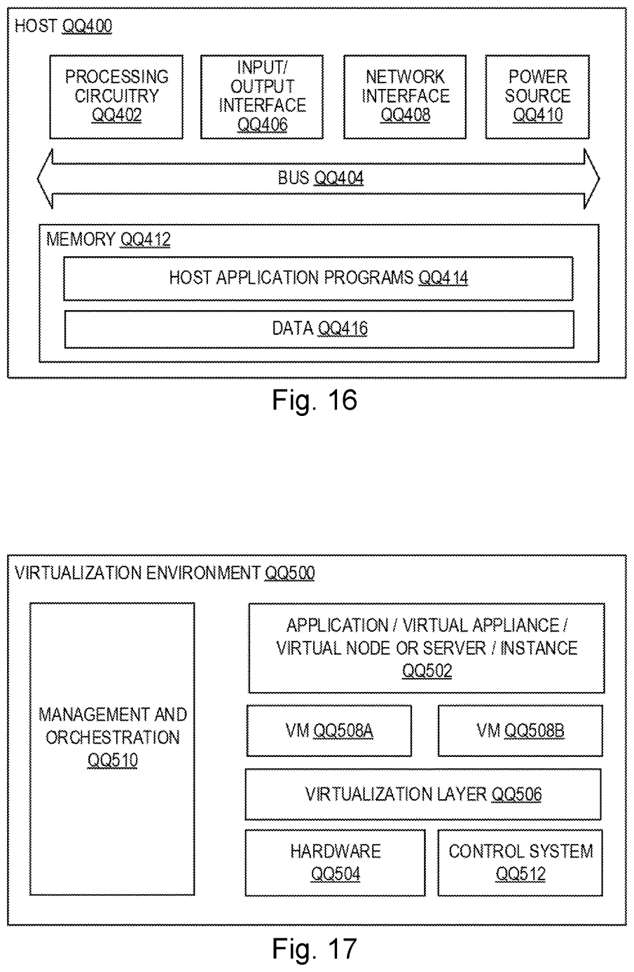

FIG. 16 is a block diagram of a host QQ400, which may be an embodiment of the host QQ116 of Figure QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 14 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

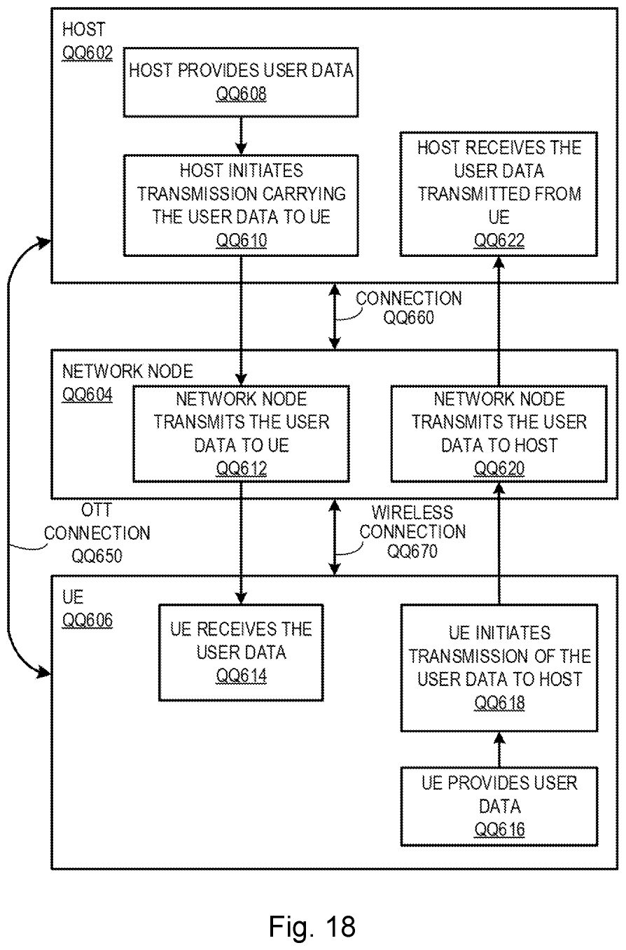

FIG. 17 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 18 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 13 and/or UE QQ200 of Figure QQ2), network node (such as network node QQ110a of FIG. 13 and/or network node QQ300 of Figure QQ3), and host (such as host QQ116 of FIG. 13 and/or host QQ400 of Figure QQ4) discussed in the preceding paragraphs will now be described with reference to Figure QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of Figure QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the control of UE transmission power independently for FD and non-FD symbols. This allows a good trade-off between maintain good SINR and not causing unnecessary interference and excess UE power consumption. Further it allows a simpler receiver implementation for scenarios where UEs typically have larger power headroom, because one can allow a higher interference level in FD symbols. and thereby provide benefits such as reduced user waiting time, better responsiveness and extended battery life.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

| Abbreviation | Explanation |
|---|---|
| FD | Full Duplex |
| SBFD | Subband Full Duplex |
| DCI | Downlink Control Information |

1-24. (canceled)

25. A method performed by a first radio node for controlling a transmission power level for transmitting one or more symbols in a channel to a second radio node in a wireless communications network, the method comprising:
obtaining, for the respective one or more symbols, one or more transmission power parameters, wherein the one or more transmission power parameters are related to the respective symbol type of the respective one or more symbols to be transmitted;
determining, based on the one or more transmission power parameters, a respective transmission power level to be used for transmitting the respective one or more symbols, wherein the respective transmission power level is determined taking an available power headroom in the first radio node into account; and
transmitting the one or more symbols with the determined respective transmission power level in the channel to the second radio node.

26. The method according to claim 25, wherein any one out of:
the one or more transmission power parameters are obtained to at least partially compensate for interference and/or noise in the channel, and
the determined transmission power level at least partially compensates for interference and/or noise in the channel.

27. The method according to claim 25, wherein the symbol type is any one out of:
a symbol where simultaneous reception and transmission is not allowed, or
a symbol where simultaneous reception and transmission is allowed.

28. The method according to claim 25, wherein the one or more transmission parameters comprises any one or more out of:
one or more open loop transmission power parameters, and
one or more closed loop transmission parameters.

29. The method according to claim 25, wherein the method further comprises:
obtaining one or more transmission power adjustments parameters from the second radio node, and wherein the respective transmission power level is further determined based on the one or more transmission power adjustments parameters.

30. The method according to claim 25, wherein obtaining the one or more transmission power parameters comprises measuring a downlink power of downlink symbol and determining a transmission power parameter based on the measured downlink power.

31. A method performed by a second radio node for controlling a transmission power level for a transmission of one or more symbols in a channel from a first radio node to the second radio node in a wireless communications network, the method comprising:
determining one or more transmission power adjustments parameters for the transmission of the one or more symbols in the channel from the first radio node to the second radio node,
providing the one or more transmission power adjustments parameters to the first radio node, and
receiving the one or more symbols from the first radio node according to the provided one or more transmission power adjustments parameters.

32. The method according to claim 31, wherein any one out of:
wherein the one or more transmission power adjustments parameters enables the first radio node to at least partially compensate for interference and/or noise in the channel.

33. The method according to claim 31, wherein the one or more transmission power adjustment parameters are determined based on any one or more out of:
an observed uplink noise and/or interference in the channel,
an observed uplink Signal to Interference and Noise Ratio (SINR),
a type of downlink transmission from the second radio node,
a spatial rank of a downlink transmission from the second radio node, and
a spatial rank of an uplink transmission from the first radio node.

34. The method according to claim 31, wherein the one or more power adjustments parameters are conditionally determined based on one or more criteria.

35. A first radio node configured to control a transmission power level for transmitting one or more symbols in a channel to a second radio node in a wireless communications network, the first radio node comprising:
radio transceiver circuitry; and
processing circuitry operatively associated with the radio transceiver circuitry and configured to:
obtain, for the respective one or more symbols, one or more transmission power parameters, wherein the one or more transmission power parameters are adapted to be related to the respective symbol type of the respective one or more symbols to be transmitted,
determine, based on the one or more transmission power parameters, a respective transmission power level to be used for transmitting the respective one or more symbols, wherein the respective transmission power levels are determined taking an available power headroom in the first radio node into account, and
transmit the one or more symbols with the determined respective transmission power level in the channel to the second radio node.

36. The first radio node according to claim 35, wherein any one out of:
the one or more transmission power parameters are to be obtained to at least partially compensate for interference and/or noise in the channel, and
the determined transmission power level at least partially compensating for interference and/or noise in the channel.

37. The first radio node according to claim 35, wherein the symbol type is any one out of:
a symbol where simultaneous reception and transmission is not allowed, or
a symbol where simultaneous reception and transmission is allowed.

38. The first radio node according to claim 35, wherein the one or more transmission parameters comprise any one or more out of:
one or more open loop transmission power parameters, and
one or more closed loop transmission parameters.

39. The first radio node according to claim 35, wherein the processing circuitry is further configured to:
obtain one or more transmission power adjustments parameters from the second radio node, and wherein the respective transmission power level is further determined based on the one or more transmission power adjustments parameters.

40. The first radio node according to claim 35, wherein obtaining the one or more transmission power parameters is based on measuring a downlink power of downlink symbol and determining the one or more transmission power parameters based on the measured downlink power.
